(19) United States
(12) Patent Application Publication
(10) Pub. No.: US 2021/0091432 A1
(43) Pub. Date: Mar. 25, 2021

(54) UNIFORM FLOW DEVICE AND METHOD FOR BATTERY ENERGY- STORAGE LIQUID COOLING SYSTEM

(71) Applicant: JING-JIN ELECTRIC TECHNOLOGIES CO., LTD., Beijing (CN)

(72) Inventor: James Han, Beijing (CN)

(73) Assignee: JING-JIN ELECTRIC TECHNOLOGIES CO., LTD., Beijing (CN)

(21) Appl. No.: 16/629,923

(22) PCT Filed: Jul. 27, 2017
(86) PCT No.: PCT/CN2017/094697

§ 371 Date: Jan. 9, 2020

(30) Foreign Application Priority Data
Jul. 21, 2017 (CN) 201710599965.0

(51) Int. Cl. H01M 10/6568; H01M 10/613; H01M 10/617; H01M 10/6556; H01M 2/10; H01M 10/625

(52) U.S. Cl. CPC H01M 10/6568; H01M 10/613; H01M 10/617; H01M 2220/20; H01M 2/1077; H01M 10/625; H01M 10/6556

(57) ABSTRACT

A device for flow equalization of a liquid cooling system of battery energy storage comprises a plurality of battery modules in parallel, each of the battery modules being connected to the liquid cooling system, and being provided with a cooling-fluid feeding inlet, wherein a throttle pipe is provided in the feeding inlet, the throttle pipe is provided with a flow restriction orifice, and the cooling fluids that enter the feeding inlets are adjusted by the throttle pipes to equal pressures. The device can enable the liquid cooling system to more uniformly distribute the flow rates of the cooling fluids among battery sub-packs or modules, thereby ensuring that the battery system operates at more uniform environmental temperatures, to reduce the difference in the performances of the modules, and prolong the service lives of the batteries.

### TECHNICAL FIELD

The present disclosure relates to a device for flow equalization of a liquid cooling system of battery energy storage, wherein the device is connected to battery packs or modules and a liquid cooling system via cooling-fluid pipelines, to more uniformly distribute the flow rates of a cooling fluid within the battery packs or modules. The present disclosure further relates to a method for flow equalization of a liquid cooling system of battery energy storage.

### BACKGROUND

Among various techniques of energy storage, lithium-ion batteries have gradually become the only choice for industrial and vehicle-mounted energy storage devices due to their high energy density and good prospect of commercialization. However, the performances of energy-storage battery systems of high capacity and high power are sensitive to temperature fluctuation, and both of environments of long-term high-and-low temperatures and the accumulation of temperature difference of the system affect the lives and the performances of batteries. Therefore, in operation, an energy-storage battery system of high power must employ a dedicated cooling device for heat dissipation, and simultaneously the temperatures of various positions of the system are required to be the same to the largest extent.

Considering the heat transfer efficiency, the uniformity of temperature controlling and the difficulty in achieving, currently, liquid cooling systems have gradually become a standard configuration of large-scale battery systems. However, the current liquid cooling systems, when connected to battery packs or modules (hereinafter collectively referred to as modules), still have many defects in terms of the controlling of temperature uniformity.

A battery system is formed by a series of modules, and the heat generated in operation is accumulated within the modules. When the liquid cooling system is operating, the cooling fluid enters the modules under the driving of a circulating pump, exchanges heat with the modules, flows out, and then exchanges heat with an external heat exchanger (a heat radiator or an air conditioning), thereby bringing out the heat of the battery system, to ensure that the temperature of the system is within a suitable range. In the process, the process of the heat exchange between the modules and the cooling fluid is the most key step, the effect of which decides the efficacy of the cooling system.

The heat exchange between the modules and the cooling fluid may be considered as convective heat dissipation, and its convective-heat-transfer speed:

Φ=αA(Tw−T),

wherein Φ is the convective-heat-transfer speed (heat flow rate rw);

A is the heat transfer area (m²);

Tw is the temperature of the wall surface contacting with the fluid (° C.);

T is the average temperature of the fluid (° C.); and

α is the convective-heat-transfer coefficient.

Because the heat transfer between the modules and the tube wall is by conduction, and the thermal resistance may be considered as a constant value, the Tw may be considered as the temperature of the modules, and the temperature of the modules is decided by the heat generation speed of the modules, that is, the power of the system. The heat transfer area A is a constant value. The α is mainly influenced by the flow rate and the coefficient of turbulence of the cooling fluid. The T is the temperature of the cooling-fluid inlets of the modules.

The currently popular approach for designing liquid cooling systems is to compromise between α and T, and therefore series-connection systems and parallel-connection systems have emerged.

As shown in FIG. 1, in a series-connection system: the liquid cooling system comprises an external heat exchanger 1 and a cooling-fluid pump 2, and the cooling fluid is pushed by the cooling-fluid pump 2, sequentially passes through each of the modules, and finally flows back to the external heat exchanger 1. The external heat exchanger 1 is further provided with a liquid-level equalizer 5.

The advantage of such a system is that it can ensure that the flow rates and the coefficients of turbulence of the cooling fluid within all of the modules are similar, thereby ensuring α1=α2=α3= . . . =αn. However, because the inlet temperature of one module is the outlet temperature of the previous one module, the inlet temperatures T of the subsequent modules gradually rise, T1<T2<T3< . . . <Tn, so Φ1>Φ2>Φ3> . . . >Φn. Therefore, it can be known that, the effect of temperature equalization of the series-connection system is poor.

As shown in FIG. 2, in a parallel-connection system: the liquid cooling system comprises an external heat exchanger 1 and a cooling-fluid pump 2, and the cooling fluid is pushed by the cooling-fluid pump 2, enters the modules respectively from various inlets, and finally flows back to the external heat exchanger 1. The external heat exchanger 1 is further provided with a liquid-level equalizer 5.

The advantage of such a system is that it can ensure that the temperatures at each of the cooling-fluid inlets of the modules are the same, T1=T1=T3= . . . =Tn. However, the flow rates of the cooling fluids that enter the modules are influenced by the resistances of the pipelines and factors such as the heights of the positions of the modules in the entire vehicle and the difference in the modules, which may cause different head pressures and different flow rates of the cooling fluids at the inlets. As a result, α1>α2>α3> . . . >αn, and accordingly Φ1>Φ2>Φ3> . . . >Φn. Therefore, it can be known that, the effect of temperature equalization of the parallel-connection system is not ideal either.

### SUMMARY

Aiming at the above problems in the prior art, the present disclosure provides a device for flow equalization of a liquid cooling system of battery energy storage, wherein the battery modules are connected in parallel, and throttle pipes are provided at the inlets of the modules, thereby ensuring uniform temperatures of the modules while ensuring the effect of heat dissipation.

The present disclosure further provides a method for flow equalization of a liquid cooling system of battery energy storage.

To achieve the above objects, the technical solutions of the present disclosure are realized as follows:

The present disclosure provides a device for flow equalization of a liquid cooling system of battery energy storage, comprising a plurality of battery modules in parallel, each of the battery modules being connected to the liquid cooling system, and being provided with a cooling-fluid feeding inlet, wherein a throttle pipe is provided in the feeding inlet, the throttle pipe is provided with a flow restriction orifice, and cooling fluids that enter the feeding inlets are adjusted by the throttle pipes to equal pressures.

Optionally, an outer wall of the throttle pipe is provided with an external thread, an inner wall of the feeding inlet is provided with an internal thread, and the throttle pipe and the feeding inlet are assembled together by the external thread and the internal thread.

Optionally, the throttle pipe is provided with a clip or a snap slot, an inner wall of the feeding inlet is provided with a snap slot or a clip, and the throttle pipe and the feeding inlet are assembled together by snap fitting.

Optionally, after the throttle pipe has been inserted into the feeding inlet, the throttle pipe and the feeding inlet are assembled together by welding or adhesion.

Optionally, an end of the throttle pipe in an axial direction is provided with an top wall, the top wall is provided with one or more flow restriction orifices, areas of the flow restriction orifices of different throttle pipes are different, and by using different combinations of orifice diameters and orifice distributions, resistance coefficients with which the cooling fluids flow through the throttle pipes are adjusted and turbulence coefficients after the cooling fluids flow through the throttle pipes are increased.

Optionally, the top wall of the throttle pipe is provided with a hole or slot for fitting an assembling tool.

Optionally, the feeding inlet and a pipeline of the cooling fluid are integrally manufactured or separately manufactured; and the throttle pipe and the feeding inlet are integrally manufactured or separately manufactured.

Optionally, an outer wall of the feeding inlet is provided with a retreat stopping slot and a flange, and an inner wall of the feeding inlet is provided with a limiting mechanism, to limit and fix the throttle pipe.

A method for flow equalization of a liquid cooling system of battery energy storage, wherein the method comprises according to lengths, directions and height differences of pipelines between battery modules and a cooling-fluid pump, calculating pressure losses of cooling fluids at feeding inlets, and providing the above-described device for flow equalization of a liquid cooling system of battery energy storage, to equalize flow rates at the battery modules.

Optionally, the throttle pipes are installed into the feeding inlets when the battery modules are being installed on a vehicle; and the method is usable for centralized battery modules or distributed battery modules.

The present disclosure, by employing the above structure configuration, has the following advantages:

The present disclosure can enable the liquid cooling system to more uniformly distribute the flow rates of the cooling fluids among battery sub-packs or modules, thereby ensuring that the battery system operates at more uniform environmental temperatures, to reduce the difference in the performances of the modules, and prolong the service lives of the batteries.

The detachable structure and serialized configuration of the throttle pipes of the present disclosure can ensure a simple and easy implementing process, which facilitates to improve the generalization and standardization of the modules.

The throttle pipes of the present disclosure have a simple structure, obtain a significant effect of adjusting, and are easy to use.

### BRIEF DESCRIPTION OF DRAWINGS

FIG. 1 is a structural schematic diagram of a liquid cooling system of battery energy storage of a series-connection structure in the prior art;

FIG. 2 is a structural schematic diagram of a liquid cooling system of battery energy storage of a parallel-connection structure in the prior art;

FIG. 3 is a structural schematic diagram of a liquid cooling system of battery energy storage of the parallel-connection structure of the present disclosure;

FIG. 4 is a front view of the throttle pipe according to the present disclosure;

FIG. 5 is a front view of the assembled state of the throttle pipe and the feeding inlet according to the present disclosure;

FIG. 6 is a top view of the assembled state of the throttle pipe and the feeding inlet according to the present disclosure;

FIG. 7 is a top view of a throttle pipe according to the present disclosure;

FIG. 8 is a top view of another throttle pipe according to the present disclosure; and

FIG. 9 is a top view of yet another throttle pipe according to the present disclosure.

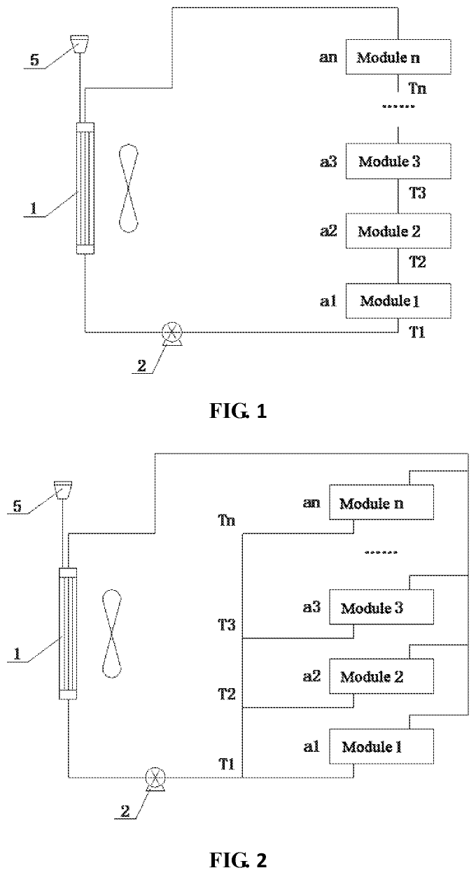

In the drawings: 1. external heat exchanger; 2. cooling-fluid pump; 3. throttle pipe; 3-1. flow restriction orifice; 3-2. hole for fitting an assembling tool; 4. feeding inlet; 4-1. retreat stopping slot; 4-2. flange; and 5. liquid-level equalizer.

### DETAILED DESCRIPTION

In order to make the objects, the technical solutions and the advantages of the present disclosure clearer, the embodiments of the present disclosure will be described below in further detail in conjunction with the drawings.

### The First Embodiment

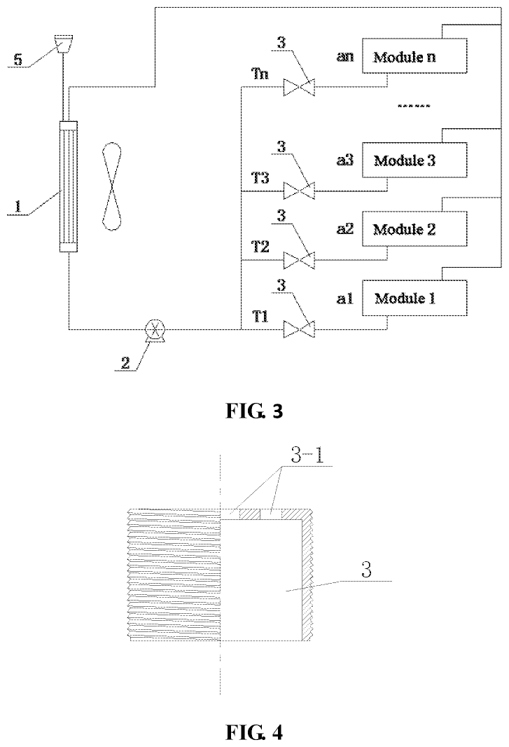

FIGS. 3, 4 and 5 show the first embodiment of the present disclosure. In the present embodiment, a device for flow equalization of a liquid cooling system of battery energy storage comprises a plurality of battery modules in parallel, which are a module 1, a module 2, a module 3, . . . , and a module n, each of the battery modules being connected to the liquid cooling system, and being provided with a cooling-fluid feeding inlet 4, wherein a throttle pipe 3 is provided in the feeding inlet 4, the throttle pipe 3 is provided with one or more flow restriction orifices 3-1, and the cooling fluids that enter the feeding inlets 4 are adjusted by the throttle pipes 3 to equal pressures.

Because the pressures of the cooling fluids are equal, the flow speeds and the flow rates of the cooling fluids tend to be equal, the convective-heat-transfer coefficients α tend to be equal, and the convective-heat-transfer speeds Φ tend to be equal.

In the present embodiment, the feeding inlet 4 and the cooling-fluid pipeline are separately manufactured, and the throttle pipe 3 and the feeding inlet 4 are separately manufactured.

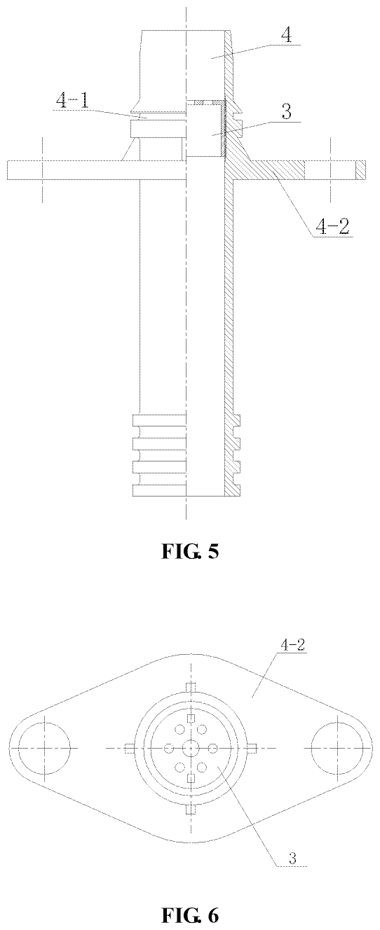

As shown in FIGS. 4 and 5, the outer wall of the throttle pipe 3 is provided with an external thread, the inner wall of the feeding inlet 4 is provided with an internal thread, and the throttle pipe 3 and the feeding inlet 4 are assembled together by the external thread and the internal thread.

The throttle pipe 3 may be manufactured by using a metallic or non-metallic material. The throttle pipe 3, compared with the throttle valves in the prior art, has a simpler structure and a lower cost, and can be installed into the feeding inlet 4, which does not increase the volume of the liquid cooling system, to facilitate the usage. After the installation, generally the pressure there is no longer required to be adjusted, so a throttle valve is not required.

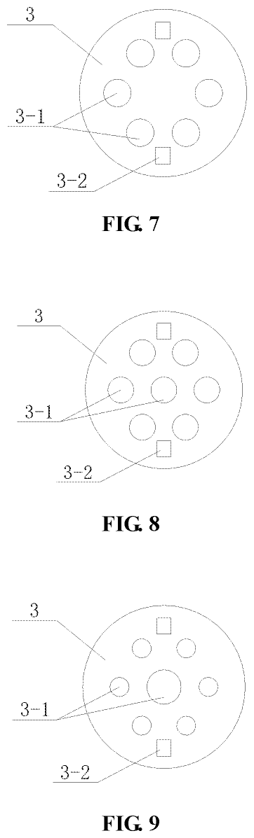

As shown in FIG. 4, an end of the throttle pipe 3 in the axial direction is provided with an top wall, the top wall is provided with a plurality of flow restriction orifices 3-1, and may also be provided with a single flow restriction orifice 3-1, the areas of the flow restriction orifices 3-1 of different throttle pipes 3 are different, as shown in FIGS. 7, 8 and 9, and by using different combinations of orifice diameters and orifice distributions the resistance coefficients with which the cooling fluids flow through the throttle pipes 3 are adjusted and the turbulence coefficients after the cooling fluids flow through the throttle pipes 3 are increased. The increasing of the turbulence coefficients after the cooling fluids flow through the throttle pipe 3 can further improve the heat exchange efficiency.

In FIG. 7, the top wall is provided with six flow restriction orifices 3-1 arranged in a circle. In FIG. 8, the top wall is provided with six flow restriction orifices 3-1 arranged in a circle and one flow restriction orifice 3-1 in the center, and the central flow restriction orifice 3-1 and the peripheral flow restriction orifices 3-1 have equal orifice diameters. In FIG. 9, the top wall is provided with six flow restriction orifices 3-1 arranged in a circle and one flow restriction orifice 3-1 in the center, and the central flow restriction orifice 3-1 has an orifice diameter greater than those of the peripheral flow restriction orifices 3-1.

In selecting the throttle pipes 3 for each of the battery modules, it is required to, according to the lengths, the directions and the height differences of the pipelines between the battery modules and a cooling-fluid pump 2, calculate the pressure losses of the cooling fluids at the feeding inlets 4, and then provide the corresponding throttle pipes 3, to equalize the flow rates at the battery modules.

For example, if the pipeline between a battery module and the cooling-fluid pump 2 is longer, has more turns, and has a greater height, it is required to install a throttle pipe 3 with a greater area of the flow restriction orifices 3-1, to increase the pressure of the cooling fluid that enters the feeding inlet 4.

If the pipeline between a battery module and the cooling-fluid pump 2 is shorter, has less turns, and has a less height, it is required to install a throttle pipe 3 with a less area of the flow restriction orifices 3-1, to reduce the pressure of the cooling fluid that enters the feeding inlet 4.

As shown in FIGS. 7, 8 and 9, the top wall of the throttle pipe 3 is provided with a hole 3-2 for fitting an assembling tool, and in installing the throttle pipe 3 the assembling tool may be inserted into the hole 3-2 to rotate the throttle pipe 3. Alternatively, that may be provided as a slot for fitting an assembling tool, wherein the slot does not penetrate through the top wall of the throttle pipe 3.

As shown in FIGS. 5 and 6, the outer wall of the feeding inlet 4 is provided with a retreat stopping slot 4-1 and a flange 4-2. In FIG. 5, an upper end opening of the feeding inlet 4 is connected to the liquid cooling system, and a lower end opening is connected to the battery module. The retreat stopping slot 4-1 can improve the fastness of the connection with the cooling-fluid pipeline, to prevent disconnection from the cooling-fluid pipeline. The flange 4-2 serves to fix the feeding inlet 4. The flange 4-2 may be integrally manufactured with the feeding inlet 4, or be separately manufactured from and then assembled together with the feeding inlet 4.

The inner wall of the feeding inlet 4 is provided with a limiting mechanism, for example a protrusion at the bottom end of the thread section, to limit and fix the throttle pipe 3, to prevent the throttle pipe 3 from entering too deep or loosening.

In the present embodiment, by manufacturing a series of throttle pipes 3 having an external thread, and designing the resistance coefficients for each of the throttle pipes 3 by accurate calculation, different pipeline resistances can be generated, thereby offsetting the influences on the α of the resistances of the cooling-fluid pipelines and of the factors such as the heights of the positions of the battery modules in the entire vehicle and the differences in the battery modules, to ensure that α1=α2=α3= . . . =αn. Because it is a parallel-connection system, the temperatures of the cooling-fluid inlets of the modules are the same; that is, T1=T2=T3= . . . =Tn, thereby reaching the target of Φ1=Φ2=Φ3= . . . =Φn.

### The Second Embodiment

The second embodiment of the present disclosure is an improvement that is made on the basis of the first embodiment. The second embodiment of the present disclosure differs from the first embodiment in that the throttle pipe 3 is provided with a clip or a snap slot, the inner wall of the feeding inlet 4 is provided with a snap slot or a clip, and the throttle pipe 3 and the feeding inlet 4 are assembled together by snap fitting.

Alternatively, after the throttle pipe 3 has been inserted into the feeding inlet 4, the throttle pipe and the feeding inlet are assembled together by welding or adhesion.

Welding or adhesion may serve as an assisting technical means for strengthening the connection, or welding or adhesion may be employed singly.

The other contents of the second embodiment of the present disclosure are the same as those of the first embodiment, and are not repeatedly described here.

### The Third Embodiment

The third embodiment of the present disclosure is an improvement that is made on the basis of the first embodiment. The third embodiment of the present disclosure differs from the first embodiment in that the feeding inlet 4 and the cooling-fluid pipeline are integrally manufactured, and the throttle pipe 3 and the feeding inlet 4 are integrally manufactured.

In the case that the feeding inlet 4 and the cooling-fluid pipeline are integrally manufactured, preferably the throttle pipe 3 and the feeding inlet 4 are integrally manufactured, which avoids the burden of installing the throttle pipe 3 in later stages.

In the case that the throttle pipe 3 and the feeding inlet 4 are integrally manufactured, the feeding inlet 4 and the cooling-fluid pipeline may be separately manufactured, because the installation of the feeding inlet 4 in later stages is still convenient.

As in the first embodiment it is required to select different types of the throttle pipes 3, in the present embodiment it is required to select different types of the feeding inlets 4, or different types of the liquid cooling system pipelines.

The other contents of the third embodiment of the present disclosure are the same as those of the first embodiment, and are not repeatedly described here.

### The Fourth Embodiment

The present embodiment provides a method for flow equalization of a liquid cooling system of battery energy storage. The method comprises according to the lengths, the directions and the height differences of the pipelines between battery modules and a cooling-fluid pump, calculating the pressure losses of the cooling fluids at feeding inlets, and then providing the corresponding device for flow equalization of a liquid cooling system of battery energy storage of the first embodiment, the second embodiment or the third embodiment, to equalize the flow rates at the battery modules.

If the device for flow equalization of a liquid cooling system of battery energy storage of the first embodiment or the second embodiment is provided, then different types of the throttle pipes 3 are installed into the feeding inlets 4 when the battery modules are being installed on a vehicle.

If the device for flow equalization of a liquid cooling system of battery energy storage of the third embodiment is provided, then when the battery modules are being installed on a vehicle it is required to install different types of the feeding inlets 4 or the liquid cooling system pipelines, or select suitable vehicle installation positions for different types of the battery modules.

The method is usable for centralized battery modules or distributed battery modules.

For example, in new energy buses, especially pure electric buses, the battery system generally, according to the space restriction, employs a distributed layout of standard cases (battery sub-packs) of different specifications. The positions and heights for installation are different, wherein generally they are deployed side by side under the floor, and laminated at the vehicle tail. When the technical solution of the present disclosure is employed, the losses of the head pressures at the inlets are calculated according to the lengths, the directions and the height differences of the pipelines between the standard cases and the cooling-fluid pump 2, and then the corresponding throttle pipes are provided, to equalize the flow rates at the cases.

Moreover, because the throttle pipes 3 are installed when the battery sub-packs are being installed on a vehicle, in the production of the standard cases in the factory the environment for the vehicle installation is not required to be taken into consideration, which greatly improves the flexibility and convenience of field work.

For example, in hybrid power vehicles or passenger cars, the battery system is generally in a centralized layout according to the enveloping space, wherein according to the demands modules of different specifications are installed in one battery pack. When the technical solution of the present disclosure is employed, the losses of the head pressures at the inlets are calculated according to the lengths, the directions and the height differences of the pipelines between the modules and the cooling-fluid pump 2, and then the corresponding throttle pipes are provided, to equalize the flow rates at the modules.

Similarly, the modules can be produced in standardized production, and the throttle pipes are installed when the battery packs are being assembled, whereby the module production is not required to take the positions into consideration, thereby improving the generalization degree and the convenience of the modules.

The above are merely particular embodiments of the present disclosure. By the teaching of the present disclosure, a person skilled in the art can make other modifications or variations on the basis of the above embodiments. A person skilled in the art should understand that, the above particular descriptions are only for the purpose of better interpreting the present disclosure, and the protection scope of the present disclosure should be subject to the protection scope of the claims.

1. A device for flow equalization of a liquid cooling system of battery energy storage, comprising a plurality of battery modules in parallel, each of the battery modules being connected to the liquid cooling system, and being provided with a cooling-fluid feeding inlet, wherein a throttle pipe is provided in the feeding inlet, the throttle pipe is provided with a flow restriction orifice, and cooling fluids that enter the feeding inlets are adjusted by the throttle pipes to equal pressures.

2. The device for flow equalization of a liquid cooling system of battery energy storage according to claim 1, wherein an outer wall of the throttle pipe is provided with an external thread, an inner wall of the feeding inlet is provided with an internal thread, and the throttle pipe and the feeding inlet are assembled together by using the external thread and the internal thread.

3. The device for flow equalization of a liquid cooling system of battery energy storage according to claim 1, wherein the throttle pipe is provided with a clip or a snap slot, an inner wall of the feeding inlet is provided with a snap slot or a clip, and the throttle pipe and the feeding inlet are assembled together by snap fitting.

4. The device for flow equalization of a liquid cooling system of battery energy storage according to claim 1, wherein after the throttle pipe has been inserted into the feeding inlet, the throttle pipe and the feeding inlet are assembled together by welding or adhesion.

5. The device for flow equalization of a liquid cooling system of battery energy storage according to claim 1, wherein an end of the throttle pipe in an axial direction is provided with an top wall, the top wall is provided with one or more flow restriction orifices, areas of the flow restriction orifices of different throttle pipes are different, and by using different combinations of orifice diameters and orifice distributions resistance coefficients with which the cooling fluids flow through the throttle pipes are adjusted and turbulence coefficients after the cooling fluids flow through the throttle pipes are increased.

6. The device for flow equalization of a liquid cooling system of battery energy storage according to claim 5, wherein the top wall of the throttle pipe is provided with a hole or slot for fitting an assembling tool.

7. The device for flow equalization of a liquid cooling system of battery energy storage according to claim 1, wherein the feeding inlet and a pipeline of the cooling fluid are integrally manufactured or separately manufactured; and the throttle pipe and the feeding inlet are integrally manufactured or separately manufactured.

8. The device for flow equalization of a liquid cooling system of battery energy storage according to claim 1, wherein an outer wall of the feeding inlet is provided with a retreat stopping slot and a flange, and an inner wall of the feeding inlet is provided with a limiting mechanism, to limit and fix the throttle pipe.

9. A method for flow equalization of a liquid cooling system of battery energy storage, wherein the method comprises according to lengths, directions and height differences of pipelines between battery modules and a cooling-fluid pump, calculating pressure losses of cooling fluids at feeding inlets, and providing the device for flow equalization of a liquid cooling system of battery energy storage according to claim 1, to equalize flow rates at the battery modules.

10. The method for flow equalization of a liquid cooling system of battery energy storage according to claim 9, wherein the throttle pipes are installed into the feeding inlets when the battery modules are being installed on a vehicle; and the method is usable for centralized battery modules or distributed battery modules.

11. A method for flow equalization of a liquid cooling system of battery energy storage, wherein the method comprises according to lengths, directions and height differences of pipelines between battery modules and a cooling-fluid pump, calculating pressure losses of cooling fluids at feeding inlets, and providing the device for flow equalization of a liquid cooling system of battery energy storage according to claim 2, to equalize flow rates at the battery modules.

12. A method for flow equalization of a liquid cooling system of battery energy storage, wherein the method comprises according to lengths, directions and height differences of pipelines between battery modules and a cooling-fluid pump, calculating pressure losses of cooling fluids at feeding inlets, and providing the device for flow equalization of a liquid cooling system of battery energy storage according to claim 3, to equalize flow rates at the battery modules.

13. A method for flow equalization of a liquid cooling system of battery energy storage, wherein the method comprises according to lengths, directions and height differences of pipelines between battery modules and a cooling-fluid pump, calculating pressure losses of cooling fluids at feeding inlets, and providing the device for flow equalization of a liquid cooling system of battery energy storage according to claim 4, to equalize flow rates at the battery modules.

14. A method for flow equalization of a liquid cooling system of battery energy storage, wherein the method comprises according to lengths, directions and height differences of pipelines between battery modules and a cooling-fluid pump, calculating pressure losses of cooling fluids at feeding inlets, and providing the device for flow equalization of a liquid cooling system of battery energy storage according to claim 5, to equalize flow rates at the battery modules.

15. A method for flow equalization of a liquid cooling system of battery energy storage, wherein the method comprises according to lengths, directions and height differences of pipelines between battery modules and a cooling-fluid pump, calculating pressure losses of cooling fluids at feeding inlets, and providing the device for flow equalization of a liquid cooling system of battery energy storage according to claim 6, to equalize flow rates at the battery modules.

16. A method for flow equalization of a liquid cooling system of battery energy storage, wherein the method comprises according to lengths, directions and height differences of pipelines between battery modules and a cooling-fluid pump, calculating pressure losses of cooling fluids at feeding inlets, and providing the device for flow equalization of a liquid cooling system of battery energy storage according to claim 7, to equalize flow rates at the battery modules.

17. A method for flow equalization of a liquid cooling system of battery energy storage, wherein the method comprises according to lengths, directions and height differences of pipelines between battery modules and a cooling-fluid pump, calculating pressure losses of cooling fluids at feeding inlets, and providing the device for flow equalization of a liquid cooling system of battery energy storage according to claim 8, to equalize flow rates at the battery modules.
